(19) United States
(12) Patent Application Publication
(10) Pub. No.: US 2010/0088608 A1
(43) Pub. Date: Apr. 8, 2010

(54) Online Community Building Portal System, Methods of Operation, And Storage Medium

(75) Inventors: Lonnie Schiller, Houston, TX (US); Nicholas Phillips, Houston, TX (US)

Correspondence Address: HULSEY IP INTELLECTUAL PROPERTY LAWYERS, P.C., 919 Congress Avenue, Suite 919, AUSTIN, TX, 78701, US

(73) Assignee: Culture Map, LLC

(21) Appl. No.: 12/247,493

(22) Filed: Oct. 8, 2008

(51) Int. Cl. G06F 3/048

(52) U.S. Cl. 715/740

(57) ABSTRACT

A system, method, and storage medium for an online community building portal, including at least one contributor, where the contributor produces and submits content localized for a particular geographic area which is then reviewed by at least one editor who is familiar with the particular geographic area; at least one computer communicably coupled to a remote computer where the computer can transmit the reviewed content to a user who is using the remote computer in a single viewer which is customizable by the user.

### FIELD OF THE INVENTION

This invention pertains generally to an online community building portal.

### BACKGROUND OF THE INVENTION

Online portals are well known in the art. Existing portals provide a user customizable interface, content from multiple outside sources, and occasionally even content derived from users. However, these existing online portals fall short in several respects. First is the concept of user accountability. While allowing users to contribute seems like a good idea, without any accountability it can soon lead to a loss of credibility for the entire portal. When users are allowed to create accounts without tying them to a real person, there is no way for another user to determine who has actually provided the content they are viewing. Consequently, some users will produce content that is incorrect, inflammatory, or otherwise malicious. This lowers the overall credibility and desirability of the portal. Furthermore, without tying a user account to an actual person, there is little hope of producing an online portal with the ability to actually build the community. Users have to be able to rely that there is some form of accountability before trusting the content or input of other users.

Next, there is a lack of locally focused content. Most portals encompass vast geographic areas. While appealing to some, there is little hope of building a geographic community from the interaction on the portal. Furthermore, the content provided by the portal, or its users, is often too broad to engage many users. This content lacks sufficient emphasis on local happenings and therefore, has less of a chance of engaging a particular geographic community to participate in community building.

Third, which is related to the lack of locally focused content, is the lack of a localized editorial voice. Existing online portals have administrators that act in some capacity as an editor. However, because the administrators are usually in communities distant from the users, the administrators lack the ability to provide a localized editorial voice. Again, this thwarts any attempt at community building and provides a less than adequate arena for true community building.

Additionally, existing online portals have not adopted the latest cutting edge technology. Therefore, they lack the ability to provide a content rich environment with up to date information produced by multiple provider. Existing online portals are generally just a conglomeration of feeds from other websites. This is most similar to a newspaper printing only wire feeds with no unique content. This lack of up to date unique content severely hampers the growth potential of the online portal.

Continuing, existing online portals lack a comprehensive invitation system. To have a truly community building online portal, one needs to have a way for users to interact both inside the portal and outside the portal. If the online portal only provides a means for users to interact while online, no real community building can occur.

Finally, existing online portals do not provide users with suggested itineraries to help users explore and experience their particular geographic area. Users are left to dig through the non-targeted information without a local focus in the hopes the user will stumble across some nugget of information that actually pertains to their particular geographic area. Again, this lack of localized sample itineraries further inhibits the existing online portals ability at true community building.

### BRIEF SUMMARY OF THE INVENTION

There is a need for a system that delivers locally focused content that is sufficiently specific yet relevant to a defined set or sets of demographics, user accountability, a fresh locally driven editorial voice, while leveraging cutting edge technology. Additionally, there is a need for such a system that also enables a comprehensive invitation system that preferably allows users to integrate the provided localized content within the invitation. Finally, there is a need for such a system that also provides sample and suggested itineraries to user to enable the users to experience new and/or different aspects of the particular geographic area.

The disclosed subject matter provides an online portal with localized information reviewed by local insiders. The information is provided not only by the local insiders but other contributors in the community. Any number of contributors are enabled to port their content into the online portal which, pending review by the administrators who are local insiders, conglomerates the information in a single viewer which each user may customize. By verifying the identity of the users, all users of the online portal can be more confident the contributions are genuine. Further, it enhances users' likelihood of interacting with other users secure in the knowledge that everyone is “real.” By increasing interaction between users within a geographic area, community building is drastically increased.

Additionally, the disclosed subject matter provides a comprehensive invitation system that enables users to conglomerate content provided by the online portal into an invitation and disseminate the invitation to people of the user's choosing.

Finally, the disclosed subject matter provides an itinerary system that provides users sample/suggested itineraries. These itineraries can be created by editors familiar with the particular geographic area, the system itself through interpolating user and editor actions, choices, preferences, and other data, and by users after review.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of the accompanying claims.

### BRIEF DESCRIPTIONS OF THE DRAWINGS

The novel features believed characteristic of the invention are set forth in the claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 illustrates a computer system and related peripherals that may operate with the interactive metro guide of the present embodiment.

FIGS. 2 and 2a depict graphical representations of the main graphical user interface (“GUI”) of the present embodiment.

FIG. 3 depicts the main GUI with the categories tab expanded.

FIGS. 4 and 4a depict the main GUI with reference to several individual points of interest (“POI”).

FIGS. 5 and 5a depict the in-depth information window.

FIG. 6 depicts the GUI displaying a particular category of POI.

FIG. 7 depicts a graphical screenshot of the dashboard concept of the disclosed subject matter.

FIG. 8 depicts an exemplary graphical depiction of a compiled invitation.

### DETAILED DESCRIPTION OF ILLUSTRATIVE EMBODIMENTS

Unless the context clearly discloses an alternate meaning, the words marker, image, and icon are used interchangeably throughout this disclosure. Similarly, unless the context clearly discloses an alternate meaning, the words category and genre are used interchangeably throughout this disclosure. Finally, unless the context clearly discloses an alternate meaning, the words venue, attraction, and point of interest are used interchangeably throughout this disclosure.

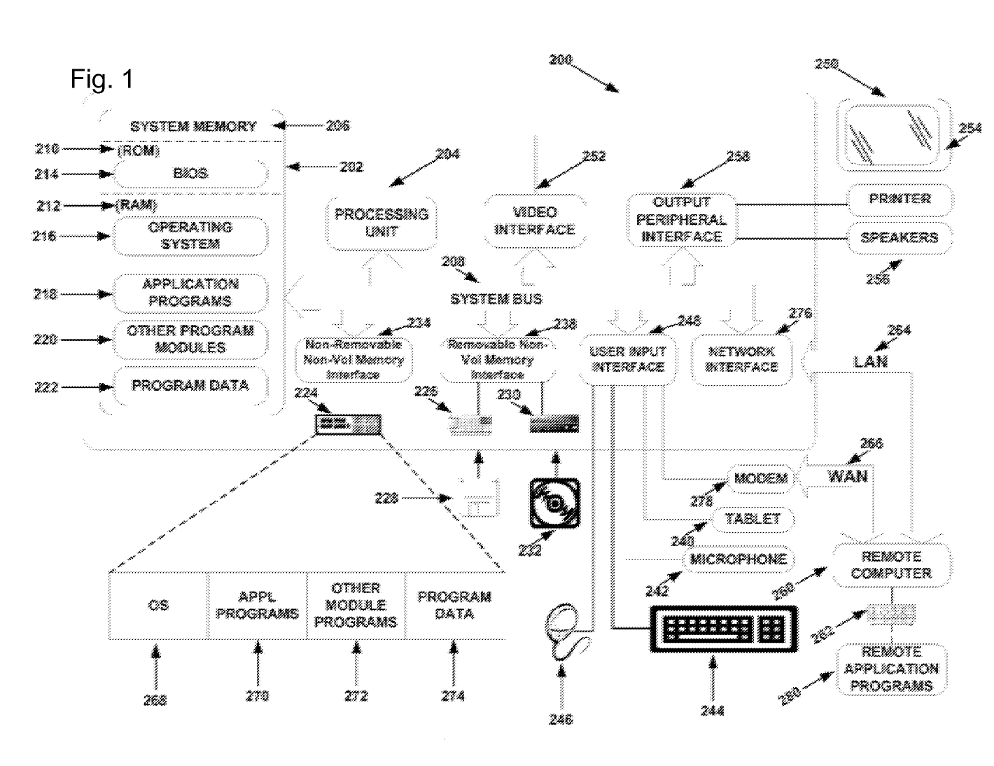

With reference to FIG. 1, an exemplary system within a computing environment for implementing the invention includes a general purpose computing device in the form of a computing system 200, commercially available from Intel, IBM, AMD, Motorola, Cyrix and others. Components of the computing system 202 may include, but are not limited to, a processing unit 204, a system memory 206, and a system bus 236 that couples various system components including the system memory to the processing unit 204. The system bus 236 may be any of several types of bus structures including a memory bus or memory controller, a peripheral bus, and a local bus using any of a variety of bus architectures.

Computing system 200 typically includes a variety of computer readable media. Computer readable media can be any available media that can be accessed by the computing system 200 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 200.

The system memory 206 includes computer storage media in the form of volatile and/or nonvolatile memory such as read only memory (ROM) 210 and random access memory (RAM) 212. A basic input/output system 214 (BIOS), containing the basic routines that help to transfer information between elements within computing system 200, such as during start-up, is typically stored in ROM 210. RAM 212 typically contains data and/or program modules that are immediately accessible to and/or presently being operated on by processing unit 204. By way of example, and not limitation, an operating system 216, application programs 220, other program modules 220 and program data 222 are shown.

Computing system 200 may also include other removable/non-removable, volatile/nonvolatile computer storage media. By way of example only, a hard disk drive 224 that reads from or writes to non-removable, nonvolatile magnetic media, a magnetic disk drive 226 that reads from or writes to a removable, nonvolatile magnetic disk 228, and an optical disk drive 230 that reads from or writes to a removable, nonvolatile optical disk 232 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 224 is typically connected to the system bus 236 through a non-removable memory interface such as interface 234, and magnetic disk drive 226 and optical disk drive 230 are typically connected to the system bus 236 by a removable memory interface, such as interface 238.

The drives and their associated computer storage media, discussed above, provide storage of computer readable instructions, data structures, program modules and other data for the computing system 200. For example, hard disk drive 224 is illustrated as storing operating system 268, application programs 270, other program modules 272 and program data 274. Note that these components can either be the same as or different from operating system 216, application programs 220, other program modules 220, and program data 222. Operating system 268, application programs 270, other program modules 272, and program data 274 are given different numbers hereto illustrates that, at a minimum, they are different copies.

A user may enter commands and information into the computing system 200 through input devices such as a tablet, or electronic digitizer, 240, a microphone 242, a keyboard 244, and pointing device 246, commonly referred to as a mouse, trackball, or touch pad. These and other input devices are often connected to the processing unit 204 through a user input interface 248 that is coupled to the system bus 208, but may be connected by other interface and bus structures, such as a parallel port, game port or a universal serial bus (USB).

A monitor 250 or other type of display device is also connected to the system bus 208 via an interface, such as a video interface 252. The monitor 250 may also be integrated with a touch-screen panel or the like. Note that the monitor and/or touch screen panel can be physically coupled to a housing in which the computing system 200 is incorporated, such as in a tablet-type personal computer. In addition, computers such as the computing system 200 may also include other peripheral output devices such as speakers 254 and printer 256, which may be connected through an output peripheral interface 258 or the like.

Computing system 200 may operate in a networked environment using logical connections to one or more remote computers, such as a remote computing system 260. The remote computing system 260 may be a personal computer, a server, a router, a network PC, a peer device or other common network node, and typically includes many or all of the elements described above relative to the computing system 200, although only a memory storage device 262 has been illustrated. The logical connections depicted include a local area network (LAN) 264 connecting through network interface 276 and a wide area network (WAN) 266 connecting via modem 278, but may also include other networks. Such networking environments are commonplace in offices, enterprise-wide computer networks, intranets and the Internet.

For example, in the present embodiment, the computer system 200 may comprise the source machine from which data is being migrated, and the remote computing system 260 may comprise the destination machine. Note however that source and destination machines need not be connected by a network or any other means, but instead, data may be migrated via any media capable of being written by the source platform and read by the destination platform or platforms.

The central processor operating pursuant to operating system software such as IBM OS/2®, Linux®, UNIX®, Microsoft Windows®, Apple Mac OSX® and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

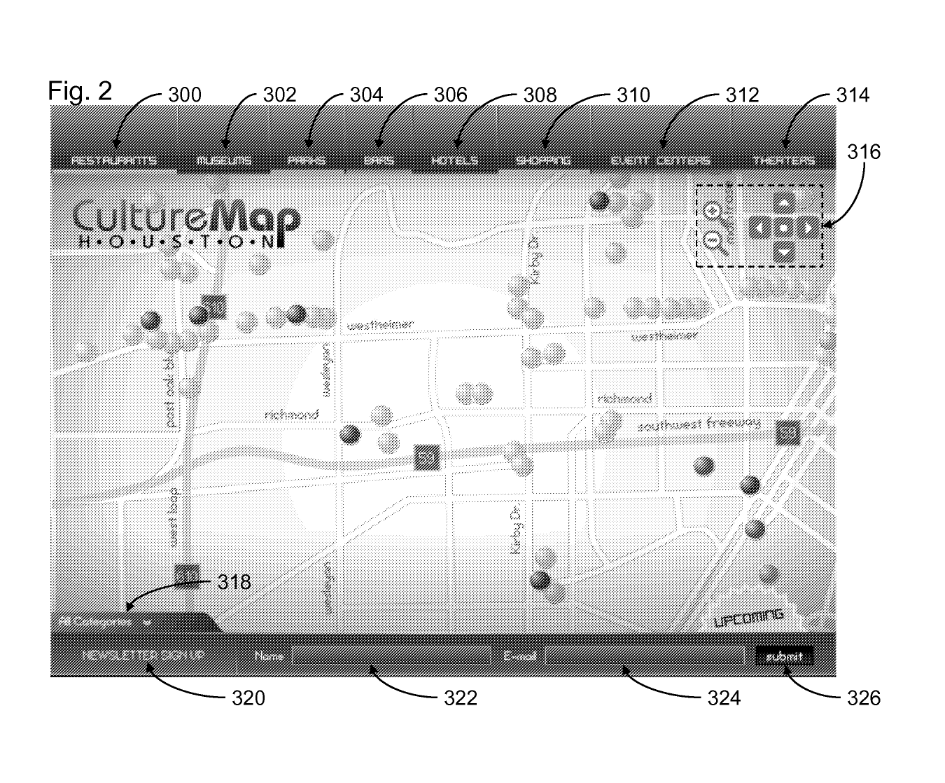

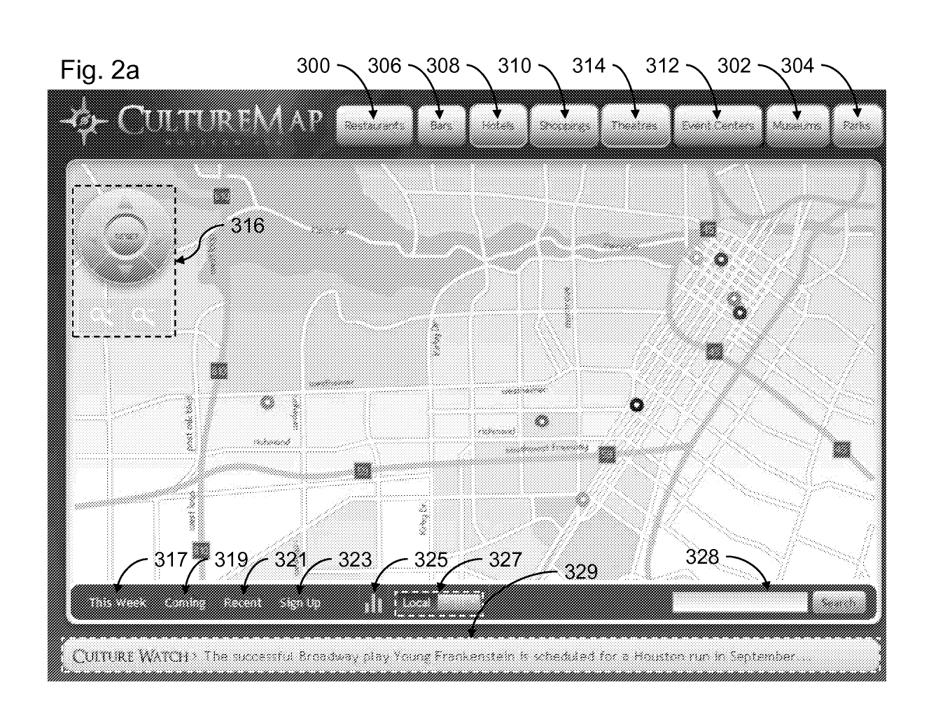

FIGS. 2 and 2a depict graphical representations of the main GUI of the present embodiment. After the user connects to the system, for example, via the Internet, the user is presented with the main GUI. The main GUI depicts different POI superimposed onto a map. In the preferred embodiment, the map is a street map of a particular geographic area and the POI represent different attractions or activities. POI are positioned in approximate correlation on the street map as their real location. However, the street map is not an all inclusive street map. It does not list every available attraction, or even every single street. The street map is a heavily editorialized street map where a team of insiders familiar with the area and culture handpick POI to include on the street map. By editorializing the street map, users receive a far richer and gratifying experience because the user can rest assured that people knowledgeable with the area have personally taken the time to become familiar with the POI and by adding the POI to the map, have given their recommendation to it. Referring to both FIGS. 2 and 2a, the POI are grouped by category or genre such as: restaurants 300, museums 302, parks 304, bars 306, hotels 308, shopping 310, event centers 312, and theaters 314. This geographic representation of multiple POI provides a significant enhancement over existing city guides because it allows users to immediately assess other POI in close proximity to each other. This allows users to find additional or alternative POI that compliment and supplement a user's outing in a quick and efficient manner. Although the foregoing specifically itemizes certain categories, this disclosure is intended to include other categories of POI as would be clear to one with skill in the art, including, but not limited to: clubs, music venues, nightclubs, stores, recreation areas, sporting venues, churches, historical buildings, historical markers, and other POI. Further, subcategories of each of the foregoing can also be foreseen such as: art museums, history museums, state history museums, dance clubs, night clubs, different musical styles of dance clubs, live music venues, types of sporting venues, etc.

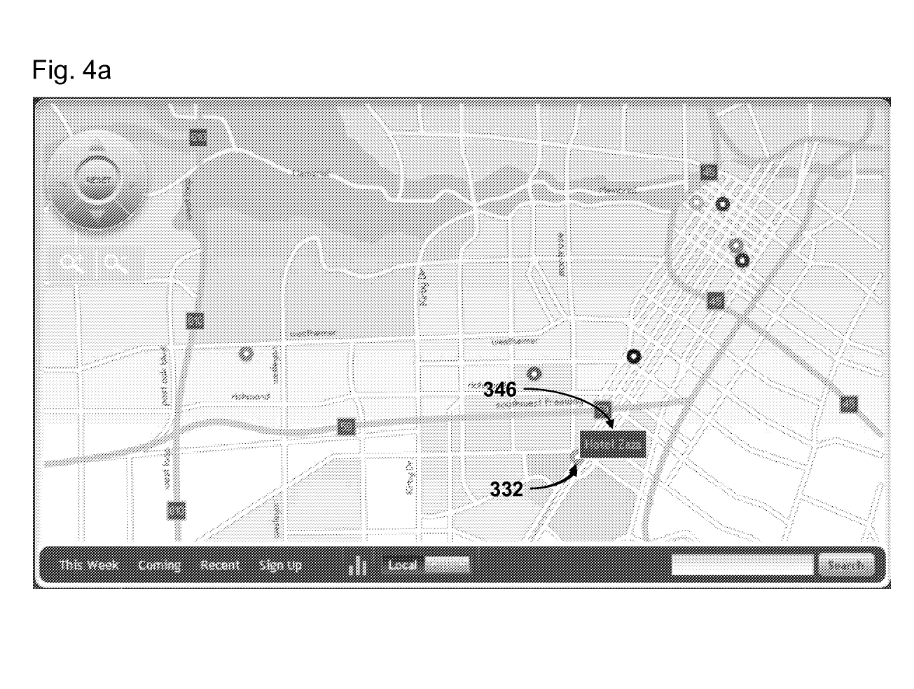

Returning to FIGS. 2 and 2a, each POI is represented on the map with an indicator or marker. In the preferred embodiment, the marker is a circle that is color coded to a particular category of POI (see FIG. 4). This functionality aides the user in quickly identifying both similar and dissimilar categories of POI. However, the marker could be any image or icon capable of identifying a location on a map. The main GUI also has navigation controls 316. These navigation controls allow the user to zoom in or out, pan the map North, South, West, or East, and reset the map to show all POI. The user will also be able to move the map in any direction by “grabbing” and moving the map. For example, a user could move the map by clicking, holding, and moving the map with a mouse. Referring to FIG. 2, the GUI also provides fields for users to sign up for a newsletter 320, including the user's name 322 and email address 324, and a way to submit the information 326. Finally, there is also a tab to expand the categories to show all POI listed under each category 318. Referring to FIG. 2a, additional functionality is shown. Specifically, the “this week” 317, “coming” 319, and “recent” 321 buttons provide insider information on upcoming events. The “sign up” button allows users to subscribe for a newsletter and other opportunities. The local/visitor 327 switch customizes the content delivered to the user based on whether the user identifies themselves as a local or a visitor. The content customization is based on insider information and general insight into what most locals or visitors would enjoy seeing and doing. Additionally, a search 328 box is provided to permit users to search for specific POI and/or events. Finally, current local “headline” style information is provided 329.

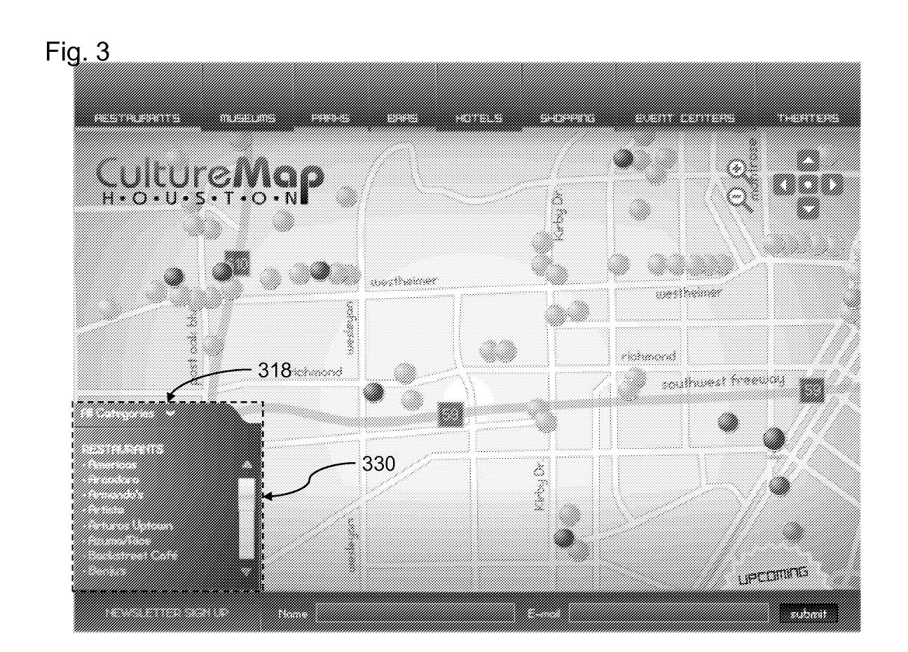

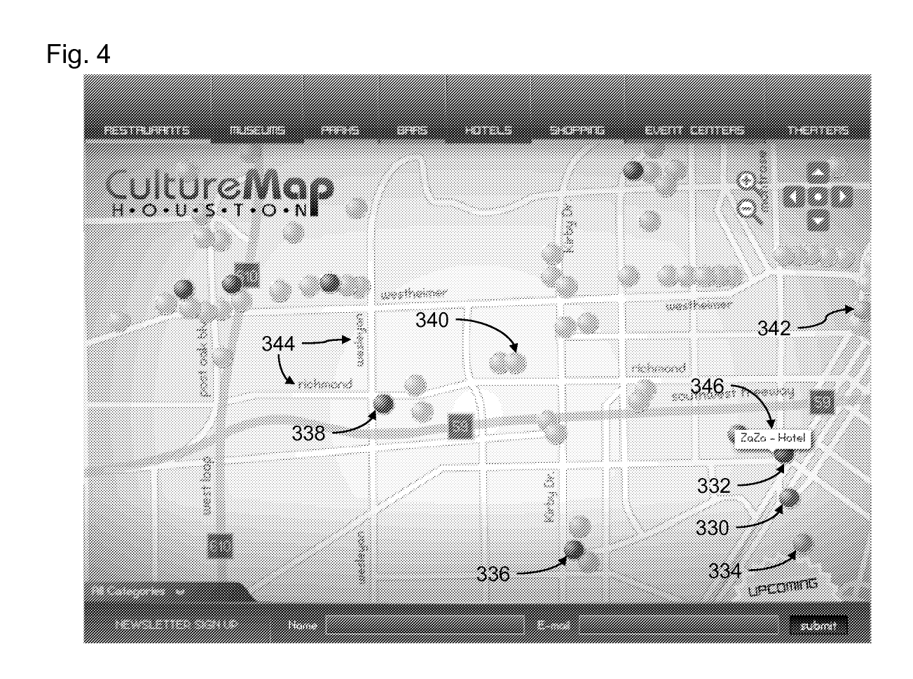

FIG. 3 depicts the main GUI with the categories tab 318 expanded. When the categories tab 318 is expanded, a listing of all POI under each category is shown 330. Therefore, if a user looked under restaurants, the user would see a list of all the restaurants displayed as POI on the GUI. This provides the user an alternate way of locating a particular POI. If the user clicked on one of the listed POI, the map would automatically center itself on the POI. Further, in the preferred embodiment, the marker corresponding to the selected POI would change such that the user could easily identify which marker correlated to the selected POI. For example, the marker could: change color, change shape, move slightly, pulsate, blink, etc.

FIGS. 4 and 4a depict the main GUI with reference to several individual POI. As discussed previously, each POI is represented by some image or icon superimposed on a map. Further, each POI image, icon, or marker is color coded to a particular category of POI. Referring to FIG. 4, for example, restaurants could be yellow 340, museums—purple 330, parks—green 334, bars—light blue 342, hotels—red 332, shopping—dark blue 336, event centers—dark green, and theaters—pink 338. This functionality aides the user in quickly identifying both similar and dissimilar categories of POI. Although the foregoing is discussed with reference to particular colors being correlated to particular categories of POI, this disclosure is intended to encompass any color being assigned to any category or sub-category of POI. Therefore, by merely glancing at the GUI, a user could immediately determine there is a theatre 338 at the intersection of Richmond and Wesleyan 344. Referring to both FIGS. 4 and 4a, when a user moved their cursor over one of the POI (commonly referred to as “rolling over”), a small pop-up could list basic information about that particular POI. For example, when a user moved a cursor over the POI 332, a small pop-up appears giving the name of that particular POI—in this case, the name of the hotel “ZaZa” 346. This basic information could include, but is not limited to: name, address, phone number, and category of attraction. Therefore, referring back to FIG. 4, if the user were staying at the ZaZa hotel 346, the user could immediately identify what other POI are in close proximity to the hotel by scanning the GUI and noting the color of the markers in close proximity to the hotel. In this example there is a museum 330 and a park 334 close to the hotel. The user would need only to scroll over the close markers to get additional basic and/or in-depth information.

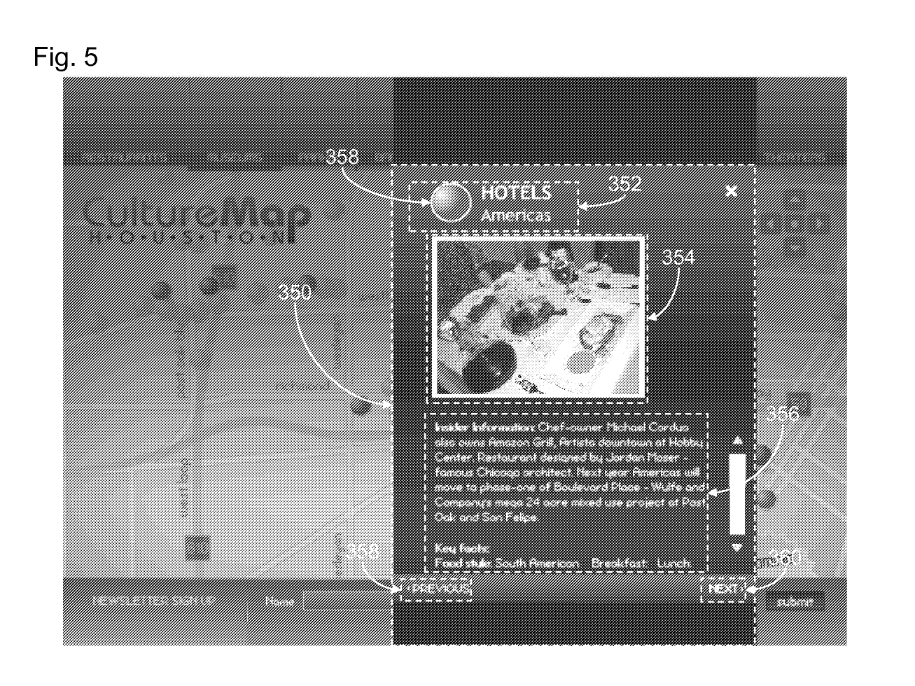

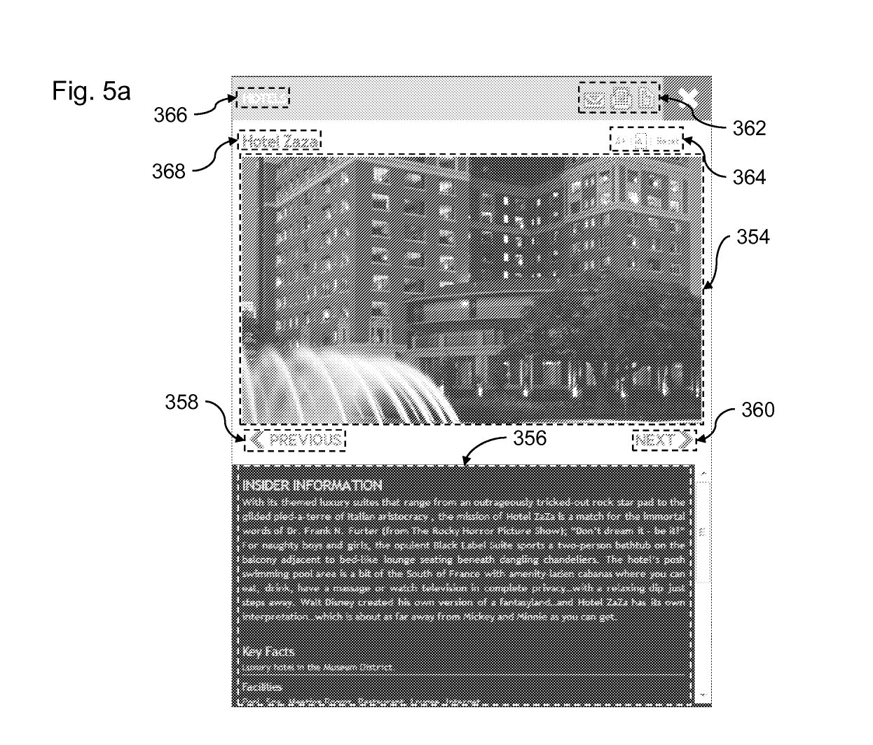

FIGS. 5 and 5a depict the in-depth information window. When a user selects a particular POI, additional in-depth information is provided. For example, referring to FIG. 5, if a user clicked on the POI for the hotel Americas, the in-depth information window 350 for Americas would be displayed. The name and category 352 of the user's selection is displayed as is the color coded icon, image, or marker assigned to that particular category 358 to assist in quick identification of the category. Referring to both FIGS. 5 and 5a, one or more pictures, videos, or other visual identifications of the POI could be displayed 354. This provides an opportunity to deliver significant information on the selected POI that would otherwise be tedious to convey. For example, a picture or video could quickly depict the relative dress or sophistication of a restaurant, the general layout of a hotel, amenities, or other features. Additional in-depth information 356 would be provided below the picture/video 354. This additional in-depth information 356 could include, but is not limited to: name, address, phone number, email, genre of attraction, fax number, specials, reviews, ratings, awards, events, hours, schedule, background, website links, menus, food style, prices, photos, specials, coupons, and store listings. Finally, the user is provided the ability to browse to the previous 358 or next 360 POI. An important feature of the present invention is this additional information will come from local insiders who are familiar with the particular POI, the city, and neighborhood characteristics. This provides a far richer and informative experience for users. In the preferred embodiment, the user would be able to browse to the previous or next POI in alphabetical order within the category. In an alternative embodiment, the user would be able to browse to the next closest POI in the category. In yet another embodiment, the user could browse to the next closest POI in any category. Referring now to FIG. 5a, the category 366 could be displayed separate from the name of the attraction 368 without use of the image or icon associated with that particular category. Additionally, usability buttons 362 and 364 could provide extended functionality such as: email the information, print the information, view the information in a different format (e.g. portable document format—“PDF”), make the text larger, make the text smaller, and return to the default view.

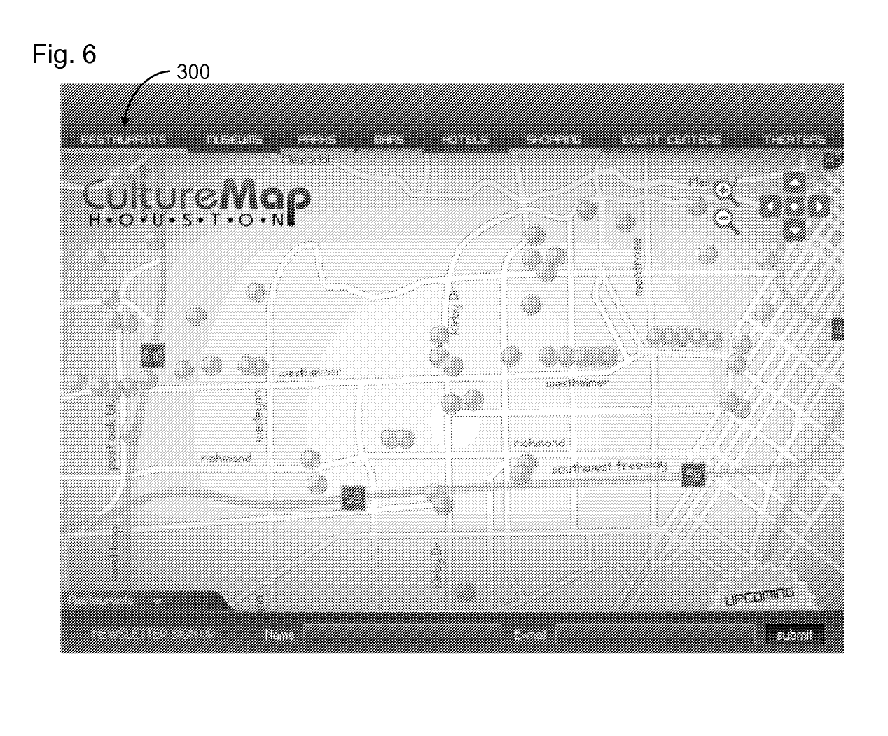

FIG. 6 depicts the GUI displaying only a particular category of POI. The user has the ability to only show POI within certain categories. For example, FIG. 6 shows the GUI after a user has selected to display only restaurants 300. This allows the user to tailor the GUI to only display markers for categories of POI the user is particularly interested in. Therefore, if the user was looking for a restaurant to start an outing, the user could select to view only restaurants without the other POI interfering. After selecting a restaurant, the user could return to the main listing to see all of the POI and evaluate what other attractions to visit. For example, a user may only want to see a play or movie after dinner. After identifying the restaurant the user wanted to visit, the user could select to only view theatres on the GUI and then look at theatres close to their chosen restaurant. Although only shown with respect to restaurants, this could also be done for any other category, sub-category, or combination of categories and/or sub-categories.

In addition to providing a feature rich editorialized street map showing POI, the disclosed subject matter also provides users with suggested itineraries. These itineraries can be broken into different categories similar to the particular POI discussed previously. Specifically, as a way of illustration and not of limitation, the itineraries could be divided into: residents, out of town guests, time of the outing, theme of the outing (romantic, fun, first date, imaginative, educational, outdoors, indoors, athletic, etc.), specific neighborhood or other geographic location, complimenting a particular activity or event (opera, theater, movie, dinner, drinks, museum, etc.), and others.

In the preferred embodiment, local insiders would assemble activities that compliment one another into suggested itineraries and make those itineraries available to users. Users then have the ability to experience new locations and activities, compliment and expand a particular event, or otherwise spice up there day or night life. In an alternative and/or complimentary embodiment, users would be invited to suggest itineraries which would then be reviewed by the local insiders to ensure accuracy, credibility, and general applicability to the overall concept prior to releasing to all users. In yet another embodiment, the system can automatically create itineraries based on user's activities. For example, if several users go to the theater and then a particular after hours club, the system could create an itinerary (this is an incredibly simple example, and the system is capable of creating for more complex itineraries from users actions and preferences). The variety of available options to include in any particular itinerary are limitless.

Additionally, users would be able to invite other users to participate in the itineraries through an “e-invitation” feature. By adding multiple users to an invitation, each invited user would receive notice of the invite and could then get additional information on the chosen itinerary. This enables groups of people to set up and distribute complex itineraries in a convenient, quick, and informative way. Finally, user created itineraries could be made public or private. If made private, only the selected users could access the itinerary.

By integrating suggested itineraries into the other offerings described herein, the disclosed subject matter offers an additional dimension to assisting users explore a particular location in an easy, simplified, content rich environment which enables users to better explore, participate, and experience what a particular area has to offer.

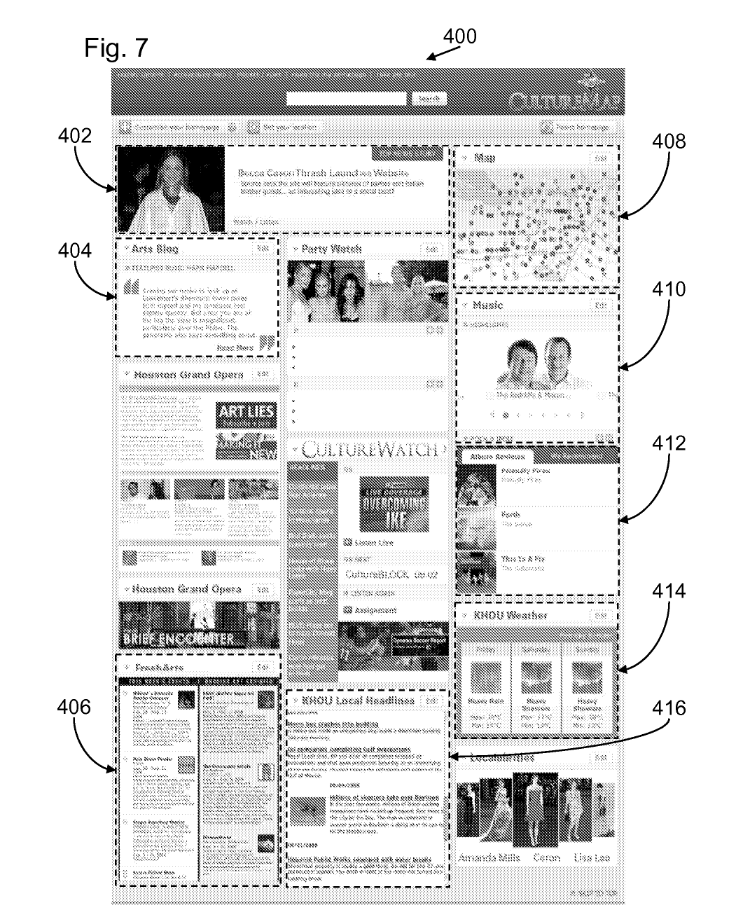

FIG. 7 depicts a graphical screenshot of the dashboard concept of the disclosed subject matter. The dashboard 400 is similar to an online magazine that is specific to a geographic area and represents the single viewer that the user would be presented with. However, the dashboard has a much broader ability. The dashboard is more like an online operating system in that it is designed to be incredibly flexible (modular based design) with a WYSIWYG (what you see is what you get) module editor and broad information processing and aggregation abilities. Integrating many of the other aspects of the disclosed subject matter into a magazine like format provides an additional way for the user to stay informed about upcoming events and happening in their region while quickly accessing other features of the disclosed subject matter. Only some of the features of the dashboard 400 will be discussed herein and are intended only as a brief sampling of information that could be contained and not an exhaustive list. The dashboard 400, would include localized information including items such as: top news story 402, excerpts from blogs 404, upcoming events and reviews 406, best of, previously disclosed editorialized map 408, music highlights 410, music reviews 412, local weather 414, and other local news items 416.

The dashboard 400 would provide a snapshot of the cultural community in a particular geographical area. Highlighting the areas cultural attractions, exhibits, and general happenings. In the preferred embodiment, the dashboard 400 encompasses news, information, commentary, and reviews on art, music, theatre, fashion, and the influential people making up those communities as well as general information such as weather and local headlines. Within these realms, the dashboard 400 would provide content rich features such as pictures, audio, and video in a magazine format. In the preferred embodiment, each portion of the dashboard 400 would link or otherwise provide access to more in depth related coverage. Again, the dashboard 400 would be heavily editorialized by local insiders familiar with the cultural happenings of a geographic area.

The dashboard 400 creates a locally focused lifestyle, social, and cultural portal that can be expanded to include wide ranging content from multiple providers. The system achieves this through a unique modular, web-based operating system. By allowing a variety of contributors to port their content into the system, easily edit, store, and distribute various forms of data, the dashboard 400 has the ability to deliver a comprehensive set of customized content to a user. The dashboard 400 differentiates itself from existing web-dash or “start page” products by its strong local focus and editorial voice.

While existing models provide for a user customizable interface, content from multiple outside sources, and even user community derived content, they fall short in several respects. Chief amongst these are the ideas of user accountability, locally focused content, content that is sufficiently specific yet relevant to a defined set or sets of demographics, a fresh editorial voice, and cutting edge technology.

The dashboard 400 enables any number of contributors to port content to the system and then allow the user to display that content in a single viewer in any number of customizable ways, while retaining the benefit of local insider editorial on the ported content.

A verification system is utilized whereby users supply verifiable data to ensure their authenticity. This verification could be achieved through a number of resources such as: PayPal, credit card verification, public records search, etc. This verification system helps to substantiate an additional aspect of the dashboard 400, which is to enable community-building. By providing locally focused and verified information, the credibility and reliability of the information increases the user's confidence in, reliance on, and ultimate use of the provided content.

Keeping with the locally driven core, the users will be able to interact with other users with similar interests while having confidence in the knowledge that everyone participating has been verified and is therefore a “real” person (at least to the extent that the verification process allows). Also, keeping with the editorial review, the administrators ensure the validity and relevance of contributors to the overall pool of information provided to the system. In the preferred embodiment, contributors would not be able to directly add content to the dashboard 400. This editorial review differentiates the disclosed subject matter from existing services.

The user can define or customize the content that is displayed by category, interest, or other attribute. These filtering choices would be stored in the user's preferences and relevant content would be delivered once the user logged into the system.

As briefly discussed earlier, the community-building aspects of the disclosed subject matter are unique through their local focus and emphasis on accountability. By integrating a verification process, virtual identities are linked to actual users. Therefore, the individual user can be held accountable by the greater community for their content, actions, and views. This further enhances the ability of the system to be self-policing.

One of the unique features of disclosed subject matter is its ability to cross-reference and link the mapping, itinerary, and dashboard functionality together. For example, users could create an itinerary and/or invitation with the help of the mapping feature and link multiple pieces of content from different providers together to add reviews and other pertinent information. This linking could be accomplished through using known hypertext markup language (“HTML”) links, actually inserting the chosen content into the invitation (e.g. picture, video, text, etc.), or other means. Then, using the invitation feature, invite other users to participate and/or attend the customized itinerary.

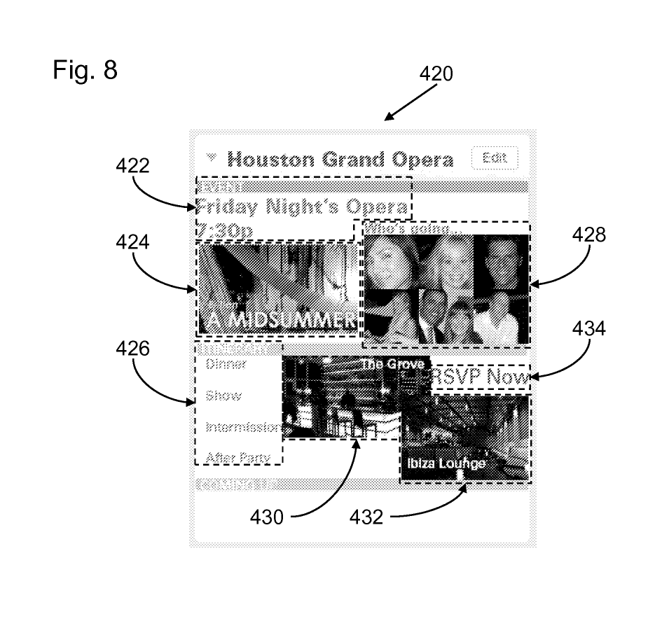

FIG. 8 depicts an exemplary graphical depiction of a compiled invitation. The invitation 420 provides pertinent information about the night's activities. A title and the time 422 are provided. Next, the user has chosen to integrate content regarding the specific opera 424 the group will see. This could be reviews, back-story, or other information regarding the opera. Next, a general overview of the itinerary is provided 426 including more integrated content regarding the nights events and stops including a restaurant 430 and a wine bar 432. Again, this additional integrated content could be reviews, comments, menus, special events, or other information. Also, the invitation shows other people who have been invited 428 and provides a means to RSVP 434. Although this example invitation included specific items, the user could provide less, more, or different information or content than is shown in this example.

Additionally, the system is able to track user behavior and actions. This usage data could be mined, conglomerated, or otherwise evaluated and analyzed to provide custom and/or targeted content based on the particular user's interests or even based on other users having similar interests. Not only could this data be used to provide individual users a more focused and applicable experience, but also to provide more targeted advertising and editorial content.

Although described with particular reference to personal computers, the claimed subject matter can be implemented on any device capable of communicating via a network, including, but not limited to: personal digital assistants, mobile digital assistants, kiosks, cellular and mobile phones, etc. Furthermore, though described with particular reference to the Internet, the claimed subject matter can be implemented via any communication medium.

Those with skill in the arts will recognize that the disclosed embodiments have relevance to a wide variety of areas in addition to those specific examples described below.

All references, including publications, patent applications, and patents, cited herein are hereby incorporated by reference to the same extent as if each reference were individually and specifically indicated to be incorporated by reference and were set forth in its entirety herein.

What is claimed is:

1. A system for a community building portal, the system comprising:
at least one contributor, wherein said contributor produces and submits content localized for a particular geographic area;
at least one editor, wherein said editor is familiar with said particular geographic area and reviews said submitted content for at least validity and relevance;
at least one user operating a remote computer, said user's identity being verified;
at least one computer communicably coupled to said remote computer via a communication medium, wherein said computer is capable of transmitting said reviewed content in a single viewer to said remote computer, wherein said single viewer is customizable by said user, and said single viewer contains an editorialized map of said particular geographic area with points of interest reviewed by said editor superimposed on said map.

2. The system of claim 1, additionally comprising an invitation component wherein said invitation component allows said user to create an invitation linking to at least one of said reviewed content.

3. The system of claim 2, wherein said communication medium is the Internet.

4. The system of claim 1, additionally comprising an itineraries component wherein said itineraries component provides at least one itinerary to said user.

5. The system of claim 4, wherein said itinerary is created by said editor.

6. The system of claim 4, wherein said itinerary is created by said computer.

7. The system of claim 4, additionally comprising an invitation component wherein said invitation component allows said user to create an invitation linking to at least one of said reviewed content.

8. A computer readable storage medium having a program for a community building portal, the program comprising the steps of:
accepting at least one submission from at least one contributor, said submission containing content localized to a particular geographic area;
reviewing said content by an editor for at least validity and relevance, said editor being familiar with said particular geographic area;
communicating between a computer and a remote computer, said remote computer operated by a user;
verifying said user's identity;
transmitting said reviewed content in a single viewer to said remote computer, said single viewer being customizable by said user and containing an editorialized map of said particular geographic area, said map of said particular geographic area containing points of interest reviewed by said editor superimposed on said map.

9. The storage medium of claim 8, with the additional step of allowing said user to create an invitation which contains at least one link to at least on of said reviewed content.

10. The storage medium of claim 9, wherein said communication step is achieved by using the Internet.

11. The storage medium of claim 8, with the additional step of providing at least one itinerary to said user.

12. The storage medium of claim 11, wherein said itinerary is created by said editor.

13. The storage medium of claim 11, wherein said itinerary is created by said computer.

14. The storage medium of claim 11, with the additional step of allowing said user to create an invitation which contains at least one link to at least on of said reviewed content.

15. A method for a community building portal, the method comprising the steps of:
accepting at least one submission from at least one contributor, said submission containing content localized to a particular geographic area;
reviewing said content by an editor for at least validity and relevance, said editor being familiar with said particular geographic area;
communicating between a computer and a remote computer, said remote computer operated by a user;
verifying said user's identity;
transmitting said reviewed content in a single viewer to said remote computer, said single viewer being customizable by said user and containing an editorialized map of said particular geographic area, said map of said particular geographic area containing points of interest reviewed by said editor superimposed on said map.

16. The method of claim 15, with the additional step of allowing said user to create an invitation which contains at least one link to at least on of said reviewed content.

17. The method of claim 15, with the additional step of providing at least one itinerary to said user.

18. The method of claim 17, wherein said itinerary is created by said editor.

19. The method of claim 17, wherein said itinerary is created by said computer.

20. The method of claim 17, with the additional step of allowing said user to create an invitation which contains at least one link to at least on of said reviewed content.
